(19) United States
(12) Patent Application Publication
(10) Pub. No.: US 2022/0405612 A1
(43) Pub. Date: Dec. 22, 2022

(54) UTILIZING USAGE SIGNAL TO PROVIDE AN INTELLIGENT USER EXPERIENCE

(71) Applicant: Microsoft Technology Licensing, LLC, Redmond, WA (US)

(72) Inventors: Madeline Schuster KLEINER, Mercer Island, WA (US); Jan Heier JOHANSEN, Tromsø (NO); Jon MELING, Tromsø (NO); Bernhard KOHLMEIER, Seattle, WA (US); Vegar Skjærven WANG, Tromsø (NO); Jignesh SHAH, Redmond, WA (US)

(73) Assignee: Microsoft Technology Licensing, LLC, Redmond, WA (US)

(21) Appl. No.: 17/349,157

(22) Filed: Jun. 16, 2021

(51) Int. Cl. G06N 5/04; G06N 20/00

(52) U.S. Cl. CPC G06N 5/04; G06N 20/00

(57) ABSTRACT

A method and system for intelligently identifying relevant application features includes receiving a request to identify the relevant application features for a file, the relevant application features being application features offered by an application associated with the file, retrieving a file usage signal, the file usage signal being a signal stored with the file and including data about user actions performed in the file over one or more sessions, providing the file usage signal as an input to a machine-learning (ML) model to identify the relevant application features based on the file usage signal, receiving from the ML model the identified relevant application features, determining a manner by which the identified relevant application features should be presented for display, and providing data relating to at least one of the identified relevant application features or the manner by which the identified relevant application should be presented to the application.

### BACKGROUND

Content creation applications often provide many different application features for creating, editing, formatting, reviewing and/or consuming content of a document. The application features may include various commands and other options provided for interacting with the content. However, most users often utilize only a small fraction of available commands in a given content creation application. Because of the large number of available commands, users often do not have the time, desire, or ability to learn about all the features provided and to discover how to find or use them. As a result, even though some of the available features may be very useful for the functions a user normally performs, they may never know about or use them.

Moreover, because some content creation applications include features in varying user interface (UI) elements, some of the available features can be difficult or time consuming to access. This could mean that even when a user is aware of a feature, they may have to click through multiple options to arrive at a desired feature. This can be time consuming and inefficient. These factors limit a user's ability to utilize an application effectively and efficiently and may limit the user's ability to accomplish desired results.

Hence, there is a need for improved systems and methods of providing an intelligent user experience in applications.

### SUMMARY

In one general aspect, the instant disclosure describes a data processing system having a processor, an operating system and a memory in communication with the processor where the memory comprises executable instructions that, when executed by the processors, cause the device to perform multiple functions. The function may include receiving a request to identify one or more relevant application features for a file, the one or more relevant application features being application features offered by an application associated with the file, retrieving a file usage signal, the file usage signal being a signal stored with the file and including data about user actions performed in the file over one or more application sessions, providing the file usage signal as an input to a machine-learning (ML) model to identify the one or more relevant application features based on the file usage signal, receiving from the ML model the identified one or more relevant application features, determining a manner by which the identified one or more relevant application features should be presented for display, and providing data relating to at least one of the identified relevant application features or the manner by which the identified relevant application should be presented to the application.

In yet another general aspect, the instant disclosure describes a method for intelligently identifying one or more relevant application features. The method may include receiving a request to identify the one or more relevant application features for a file, the one or more relevant application features being application features offered by an application associated with the file, retrieving a file usage signal, the file usage signal being a signal stored with the file and including data about user actions performed in the file over one or more application sessions, providing the file usage signal as an input to a ML model to identify the one or more relevant application features based on the file usage signal, receiving from the ML model the identified one or more relevant application features, determining a manner by which the identified one or more relevant application features should be presented for display, and providing data relating to at least one of the identified relevant application features or the manner by which the identified relevant application should be presented to the application.

In a further general aspect, the instant disclosure non-transitory computer readable medium on which are stored instructions that, when executed, cause a programmable device to perform multiple functions. The functions may include receiving a request to identify one or more relevant application features for a file, the one or more relevant application features being application features offered by an application associated with the file, retrieving a file usage signal, the file usage signal being a signal stored with the file and including data about user actions performed in the file over one or more application sessions, providing the file usage signal as an input to a machine-learning (ML) model to identify the one or more relevant application features based on the file usage signal, receiving from the ML model the identified one or more relevant application features, determining a manner by which the identified one or more relevant application features should be presented for display, and providing data relating to at least one of the identified relevant application features or the manner by which the identified relevant application should be presented to the application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A-1C illustrate an example system in which aspects of this disclosure may be implemented.

FIG. 2 illustrates an example data structure for keeping track of user activity in a file.

FIG. 3 illustrate example properties associated with a file that may be used to identify relevant application features for a file.

FIGS. 4A-4B are example graphical user interface (GUI) screens for proactive display of relevant application features.

FIG. 5 are example GUI screens for providing various degrees of proactively displaying of an application feature.

FIG. 6 is an example GUI screen 600 of a word processing application displaying an example document.

FIG. 7 is a flow diagram depicting an exemplary method for identifying and presenting relevant application features.

FIG. 8 is a block diagram illustrating an example software architecture, various portions of which may be used in conjunction with various hardware architectures herein described.

FIG. 9 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Users often create digital content using complex content creation applications that offer many different types of application features for performing various tasks. Because of the large number of available features, most content creation applications organize various sets of features in different UI elements (e.g., menu options). For example, some content creation applications utilize a toolbar menu (e.g., a ribbon) displayed in the top region of the application UI. The toolbar menu may include various tabs under each of which access to different features may be provided. In another example, content creation applications provide pop-up menus or menu panes.

Each of the UI menus may include different application features, some of which may be accessed via multiple different menus. Furthermore, some UI menu may display features at several different levels. For example, the toolbar menu may display top-level features at a top view, while sub-features (e.g., features that can be categorized under a top feature) are displayed at various sub-levels. As a result, locating a desired application feature may be challenging and time consuming. Thus, there exists the technical problem of making complex and numerous commands, features, and functions of an application easily discoverable and accessible to users.

Moreover, because of the complexity of content creation applications and the large number of available features, many users are unaware of many features available in an application. Furthermore, the large number of available commands may overwhelm some users. This may result in underutilization of many useful application features. As a result, there exists a technical problem of enabling users to learn and utilize about application features with which they are unfamiliar.

Additionally, in trying to display hundreds of features in a manner that is easily locatable, valuable screen space is often dedicated to displaying several different UI menu options at various places on the UI screen. For example, a large toolbar menu is often displayed at the top of the content creation application screen. As such, there exists another technical problem of reducing the amount of screen space dedicated to displaying application features on the application screen.

To address some of these technical problems, various content creation applications proactively display certain application features in response to specific user actions in an application session or contextual data. For instance, some content creation applications utilize pop-up menus or menu panes which may be displayed proactively in response to specific user actions. For example, clicking on a selected theme in a presentation application may result in the display of a design ideas pane. While the proactively displayed feature may be helpful to some users, it can become distracting and frustrating if the feature is not useful to a user. However, simply proactively displaying an application feature in response to a specific user action often leads to over-display of the application feature to users. As such, there exits another technical problem of accurately targeting proactive display of application features to users who are likely to use them.

To address these technical problems and more, in an example, this description provides a technical solution for utilizing one or more file usage signals to provide an intelligent user experience in an application. The intelligent user experience may include proactive display of application features and/or modification of existing UI element to target the display of application features to users who are likely to use them. To provide the intelligent user experience, techniques may be used for evaluating the user's usage signal with respect to a file, examining the user's relationships with other users, evaluating the usage signal of users with whom the user has a relationship, the user's usage category, and/or the lifecycle stage of the file. The usage signal evaluated may include the usage signal over multiple application session. To achieve this, file usage information about users' activities in the file may be collected. This information may then be analyzed to determine one or more user categories associated with the file based on users' activities, and/or lifecycle stage of the file, and identify activity patterns for the user. The determined data may then be transmitted for storage with the file and/or in a data structure associated with the user or the file. File-specific data may be stored as metadata for the file and/or may be added as new properties to the file such that it can be accessed during an active application session to provide an intelligent user experience. The intelligent user experience may include more relevant proactive launch of intelligent application features and/or organization of UI elements to display application features that are more likely to be of use to the user in a manner consistent with the features' relevance to the user.

As will be understood by persons of skill in the art upon reading this disclosure, benefits and advantages provided by such implementations can include, but are not limited to, a solution to the technical problems of inability to accurately launch application features that are relevant to a user, lack of organizational mechanisms for displaying application features that are relevant to a user, and inefficient use of UI space for displaying application features. Technical solutions and implementations provided herein optimize and improve the accuracy of identifying relevant application features for both display in an existing UI screen and proactive launch of application features. This leads to providing more accurate, useful and reliable use of UI space to display application features that are relevant to a user, and increases the precision with which relevant application features are identified and presented. The benefits provided by these solutions include more user-friendly applications and enable users to increase their efficiency. Furthermore, because more relevant application features are identified and displayed in a manner related to the user's needs, the solutions may reduce processor, memory and/or network bandwidth usage and increase system efficiency.

As used herein, “feature” may refer to a command, an option or a functionality offered by an application to perform a given task. Furthermore, as used herein, the term “electronic file” or “file” may be used to refer to any electronic file that can be created by a computing device and/or stored in a storage medium. The term “file usage signal” or “usage signal” may be used to refer to data associated with activities performed by a user with respect to a file during an application session. Moreover, the term “relevant application features” may refer to application features that are likely to be relevant to the user's current activity in a file.

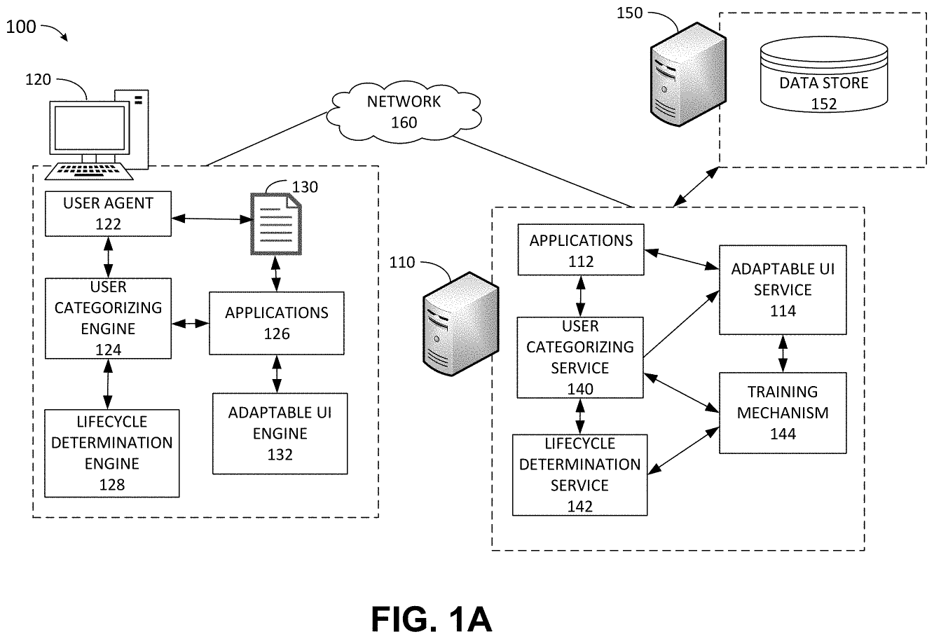

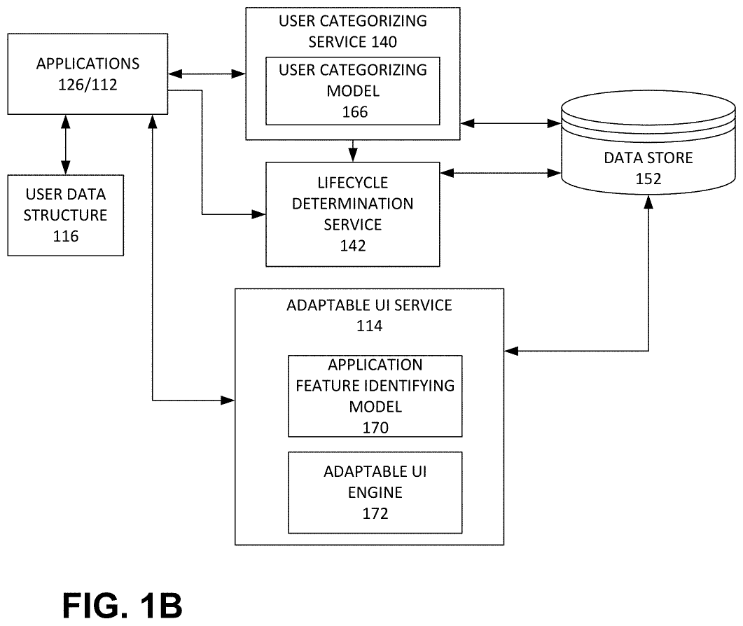

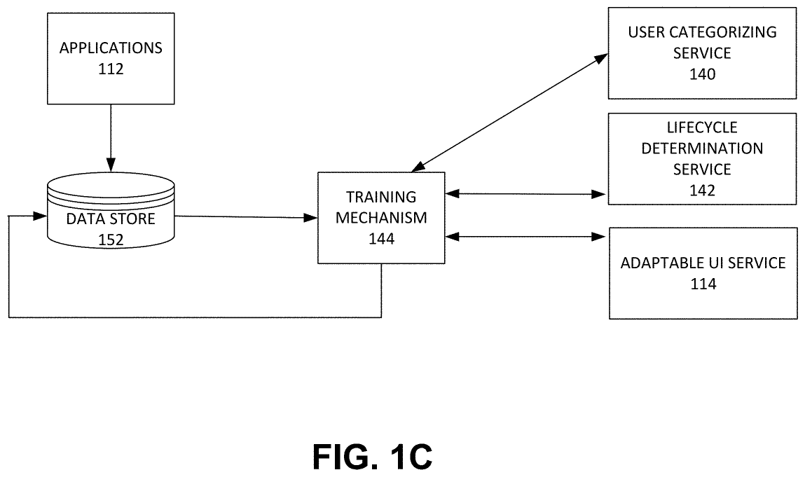

FIG. 1A illustrates an example system 100, in which aspects of this disclosure may be implemented. The system 100 may include a server 110 which may contain and/or execute a user categorizing service 140, a lifecycle determination service 142, and an adaptable UI service 114. The server 110 may operate as a shared resource server located at an enterprise accessible by various computer client devices such as client device 120. The server 110 may also operate as a cloud-based server for offering global user categorizing services, lifecycle determination services, and/or adaptable UI services. Although shown as one server, the server 110 may represent multiple servers for performing various different operations. For example, the server 110 may include one or more processing servers for performing the operations of the user categorizing service 140, the lifecycle determination service 142, and the adaptable UI service 114.

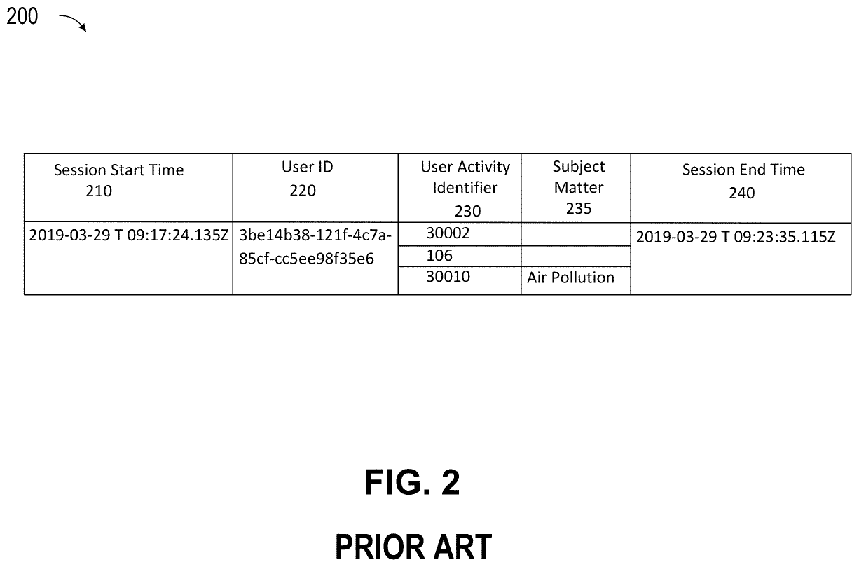

The user categorizing service 140 may provide intelligent categorization of users' roles with respect to a file over time. As described in detail with respect to FIG. 1B, the operations of the user categorization service may include receiving a file usage signal, determining based on the information provided in the usage signal, one or more user categories for the user, and providing the identified user categories for storage in association with the file. As described further with respect to FIG. 2, the file usage signal may include detailed information about the types of activities performed on a file by a user within a given time period.

The lifecycle determination service 142 may provide intelligent determination of a file's lifecycle stage. As described in detail with respect to FIG. 1B, the lifecycle determination service 142 may receive information relating to the one or more user categories identified by the user categorizing service 140 and determine based on the identified user categories an appropriate lifecycle stage for the file.

The adaptable UI service 114 may conduct intelligent identification and presentation of relevant application features. As described in detail with respect to FIG. 1B, the adaptable UI service 114 may examine the user's usage signal for a file, evaluate the user's relationship with other users having usage signals for the file, evaluate the usage signal of users' with whom the user has a relationship, examine the user's usage category, and/or evaluate the file's lifecycle stage to identify relevant application features. After identifying the relevant application features, the adaptable UI service 114 may determine how to present the identified application features to the user. A list of the relevant application features and the manner by which they should be presented to the user may then be provided by the adaptable UI service 114 for being displayed to the user.

The server 110 may be connected to or include a storage server 150 containing a data store 152. The data store 152 may function as a repository in which files and/or data sets (e.g., training data sets) may be stored. One or more machine learning (ML) models implemented by the user categorizing service 140, the lifecycle determination service 142, or the adaptable UI service 114 may be trained by a training mechanism 144. The training mechanism 144 may use training data sets stored in the data store 152 to provide initial and ongoing training for each of the models. Alternatively or additionally, the training mechanism 144 may use training data sets from elsewhere. This may include training data such as knowledge from public repositories (e.g., Internet), knowledge from other enterprise sources, or knowledge from other pre-trained mechanisms. In one implementation, the training mechanism 144 uses labeled training data from the data store 152 to train one or more of the models via deep neural network(s) or other types of ML models. The initial training may be performed in an offline stage. Additionally and/or alternatively, the one or more ML models may be trained using batch learning.

As a general matter, the methods and systems described here may include, or otherwise make use of, an ML model to identify data related to a file. ML generally includes various algorithms that a computer automatically builds and improves over time. The foundation of these algorithms is generally built on mathematics and statistics that can be employed to predict events, classify entities, diagnose problems, and model function approximations. As an example, a system can be trained using data generated by an ML model in order to identify patterns in user activity, determine associations between tasks and users, identify categories for a given user, and/or identify activities associated with specific application features or UI elements. Such training may be made following the accumulation, review, and/or analysis of user data from a large number of users over time. Such user data is configured to provide the ML algorithm (MLA) with an initial or ongoing training set. In addition, in some implementations, a user device can be configured to transmit data captured locally during use of relevant application(s) to a local or remote ML algorithm and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying MLAs, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model may be varied between different ML models, such as a maximum depth for decision trees, or a number and/or size of hidden layers in a convolutional neural network. Moreover, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

In collecting, storing, using and/or displaying any user data, care must be taken to comply with privacy guidelines and regulations. For example, options may be provided to seek consent (e.g., opt-in) from users for collection and use of user data, to enable users to opt-out of data collection, and/or to allow users to view and/or correct collected data.

The ML model(s) categorizing the user activities, determining lifecycle stages, and/or providing adaptable UI services may be hosted locally on the client device 120 or remotely, e.g., in the cloud. In one implementation, some ML models are hosted locally, while others are stored remotely. This enables the client device 120 to provide some categorization, lifecycle determination, and/or adaptable UI services, even when the client is not connected to a network.

The server 110 may also be connected to or include one or more online applications 112. Applications 112 may be representative of applications that enable a user to interactively generate, edit and/or view an electronic file such as the electronic file 130. Examples of suitable applications include, but are not limited to, a word processing application, a presentation application, a note taking application, a text editing application, an email application, a spreadsheet application, a desktop publishing application, a digital drawing application, a communications application and a web browsing application.

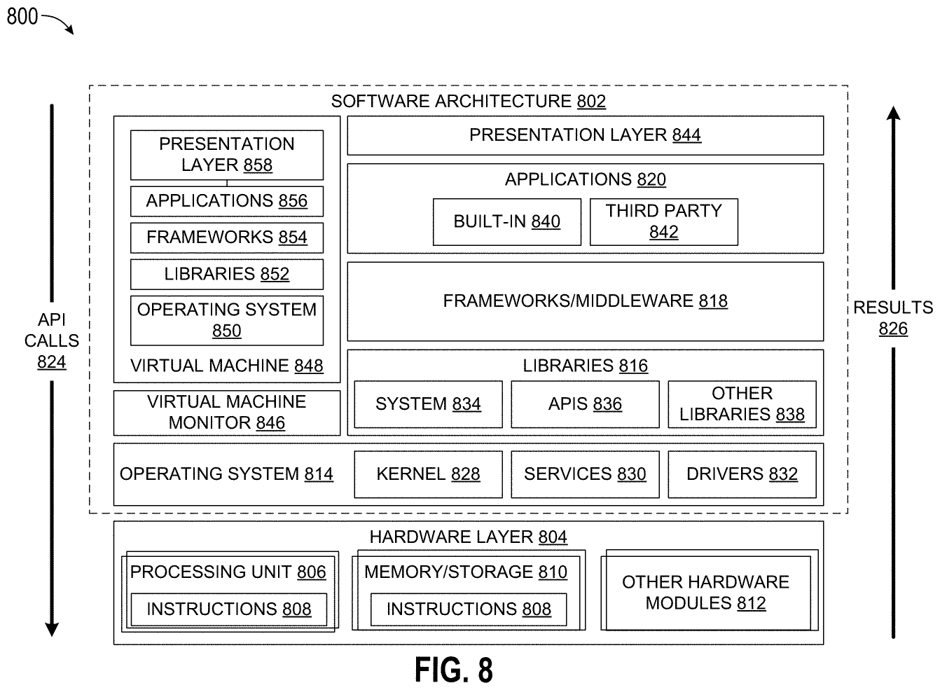

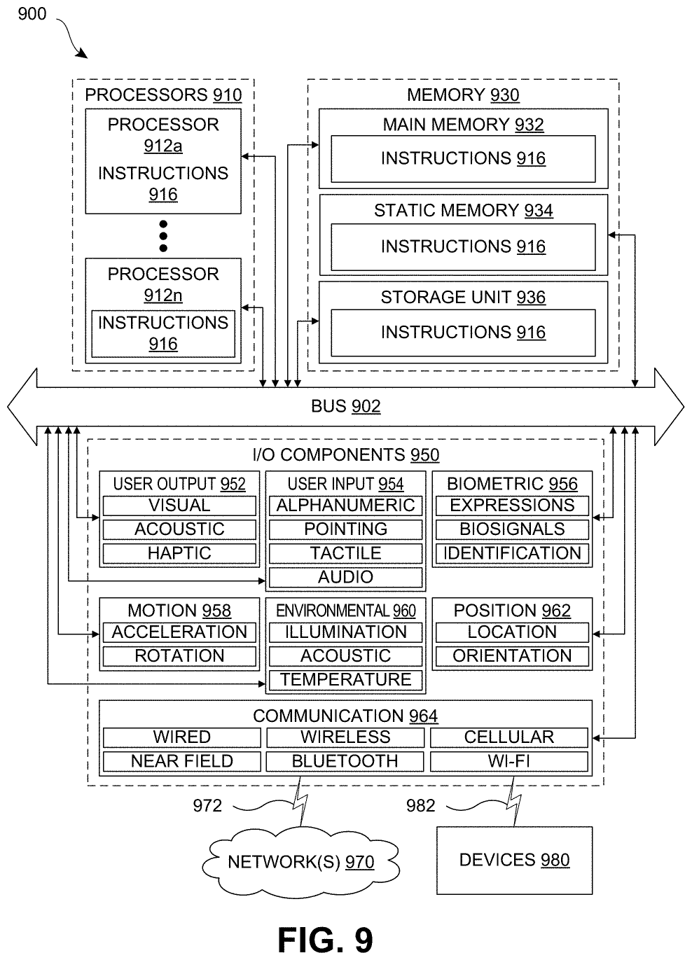

The client device 120 may be connected to the server 110 via a network 160. The network 160 may be a wired or wireless network(s) or a combination of wired and wireless networks that connect one or more elements of the system 100. In some embodiments, the client device 120 may be a personal or handheld computing device having or being connected to input/output elements that enable a user to interact with the electronic file 130 on the client device 120 and to view information about one or more files relevant to the user via, for example, a user interface (UI) displayed on the client device 120. Examples of suitable client devices 120 include but are not limited to personal computers, desktop computers, laptop computers, mobile telephones, smart phones, tablets, phablets, digital assistant devices, smart watches, wearable computers, gaming devices/computers, televisions, and the like. The internal hardware structure of a client device is discussed in greater detail with regard to FIGS. 8 and 9.

The client device 120 may include one or more applications 126. An application 126 may be a computer program executed on the client device that configures the device to be responsive to user input to allow a user to interactively generate, edit and/or view the electronic file 130. Examples of electronic files include but are not limited to word-processing files, presentations, spreadsheets, websites (e.g., SharePoint sites), digital drawings, emails, media files and the like. The electronic file 130 may be stored locally on the client device 120, stored in the data store 152 or stored in a different data store and/or server.

The applications 126 may process the electronic file 130, in response to user input through an input device to create, view and/or modify the content of the electronic file 130. The applications 126 may also display or otherwise present display data, such as a graphical user interface (GUI) which includes the content of the electronic file 130 to the user. Examples of suitable applications include, but are not limited to a word processing application, a presentation application, a note taking application, a text editing application, an email application, a spreadsheet application, a desktop publishing application, a digital drawing application and a communications application.

The client device 120 may also access the applications 112 that are run on the server 110 and provided via an online service, as described above. In one implementation, applications 112 may communicate via the network 160 with a user agent 122, such as a browser, executing on the client device 120. The user agent 122 may provide a UI that allows the user to interact with application content and electronic files stored in the data store 152 via the client device 120. In some examples, the user agent 122 is a dedicated client application that provides a UI to access files stored in the data store 152 and/or in various other data stores.

In some implementations, the client device 120 also includes a user categorizing engine 124 for categorizing a user's roles with respect to files, such as the electronic file 130. In an example, the user categorizing engine 124 may operate with the applications 126 to provide local user categorizing services. For example, when the client device 120 is offline, the local user categorizing engine 124 may operate in a similar manner as the user categorizing service 140 and may use one or more local repositories to provide categorization of user activities for a file. In one implementation, enterprise-based repositories that are cached locally may also be used to provide local user categorization. In an example, the client device 120 may also include a lifecycle determination engine 128 for determining the current lifecycle stage of a file, such as the electronic file 130. The lifecycle determination engine 128 may use the amount and/or types of activities performed on the file within a given time period along with the identified user categories (e.g., received from the local user categorizing engine 124 and/or the user categorizing service 140) to determine the current lifecycle stage of the file. The operations of the lifecycle determination engine 128 may be similar to the operations of the lifecycle determination service 142, which are discussed below with respect to FIG. 1B.

Moreover, the client device 120 may include an adaptable UI engine 132. The adaptable UI engine 132 may conduct local intelligent identification and presentation of relevant application features (e.g., locally stored files). To achieve this, the adaptable UI engine 132 may take into account the user's usage signal for a file, evaluate the user's relationship with other users having usage signals for the file, evaluate the usage signal of users with whom the user has a relationship, examine the user's usage category, and/or evaluate the file's lifecycle stage to identify relevant application features. The operations of the adaptable UI 132 may be similar to the operations of the adaptable UI service 114, which are discussed below with respect to FIG. 1B.

User categorizing service 140, lifecycle determination service 142, user categorizing engine 124, lifecycle determination engine 128, adaptable UI service 114 and/or adaptable UI engine 132 may receive usage signals from files created or edited in a variety of different types of applications 126 or 112. Once usage signals are received, the user categorizing service 140, lifecycle determination service 142, user categorizing engine 124, and lifecycle determination engine 128, adaptable UI service 114 and/or adaptable UI engine 132 may evaluate the received usage signals, regardless of the type of application they originate from, to identify appropriate user categories, lifecycle stages, and/or application features associated with the usage signals. Each of the adaptable UI service 114 and adaptable UI engine 132 service 114, user categorizing service 140, lifecycle determination service 142, user categorizing engine 124 and lifecycle determination engine 128 may be implemented as software, hardware, or combinations thereof

FIG. 1B depicts various elements included in each of the lifecycle determination service 142 and adaptable UI service 114. The user categorizing service 140 may receive data related to user activities performed in a file and identify user categories associated with the activities for a given session. To achieve this, the user categorizing service 140 may provide the data related to user activities to the user categorizing model 166 to identify the users' roles with respect to the file for the session. This process is discussed in detail in U.S. patent application Ser. No. 16/746,581, entitled “Intelligently Identifying a User's Relationship with a Document,” and filed on Jan. 17, 2020 (referred to hereinafter as “the '581 Application”), the entirety of which is incorporated herein by reference.

As discussed in the '581 Application, content creation/editing applications often offer numerous features (e.g., commands and/or other activities) for interacting with content of a file. For example, a word processing application may include one or more commands for changing the font, changing paragraph styles, italicizing text, and the like. These commands may each be associated with an identifier, such as a toolbar command identifier (TCID). In addition to offering various commands, applications may also enable user activities such as typing, scrolling, dwelling, or other tasks that do not correspond to TCID commands. These activities may be referred to as non-command activities. Each of the commands or non-command activities provided by an application may fall into a different category of user activity. For example, commands for changing the font, paragraph, or style of the file may be associated with formatting activities, while inserting comments, replying to comments and/or inserting text using a track-changes feature may correspond to reviewing activities.

To categorize user activities, commands and non-command activities provided by an application, such as applications 112, may be grouped into various user categories. An initial set of user categories may include creators, authors, moderators, reviewers, and readers. Other categories may also be used and/or created (e.g., custom categories created for an enterprise or tenant). For example, a category may be generated for text formatters. Another category may be created for object formatters (e.g., shading, cropping, picture styles). Yet another category may be created for openers, which may include users who merely open and close a file or open a file but do not perform any activities (e.g., scrolling) and do not interact with the content of the file.

To determine user categories, file usage data representing user commands used to interact with the content of the file may be collected and analyzed. This may involve tracking and storing (e.g., temporarily) a list of user activities and commands in a local or remote data structure associated with the file to keep track of the user's activity and command history. This information may be referred to as the file usage signal and may be provided by the applications 112 (e.g., periodically or at the end of an active session) to the user categorizing service 140 and/or adaptable UI service 114, which may use the information to determine which user category or categories the user activities fall into or which application features correspond to the user activities. For example, the user categorizing service 140 may determine that based on the user's activity and command history within the last session, the user functioned as a reviewer. Identification of the user category or categories may be made by utilizing an ML model that receives the usage signal as an input and intelligently identifies the proper user categories for each user session. The identified user category may then be provided by the user categorizing service 140 to the applications 126/112 and/or to the data store 152 where it may be stored as metadata for the file and/or may be added as new properties to the file for use during an initial opening of the file and/or during an active session to provide an intelligent user experience.

Moreover, the user category signal may be transmitted from the user categorizing service 140 and/or sent from the data store 152 to the lifecycle determination service 142. The lifecycle determination service 142 may utilize the identified user category and/or the underlying user activities to determine an appropriate lifecycle stage for the file. For example, when the identified user category is a reviewer, the lifecycle determination service 142 may determine that the current lifecycle stage of the file is in review. In an example, lifecycle stages include creation, authoring, editing, in review, and/or finalized.

The file usage signal, identified user categories, and/or lifecycle stages may then be provided as inputs to the adaptable UI service 114 to enable the adaptable UI service 114 to identify relevant application features. The adaptable UI service 114 may provide the receive file usage signal, identified user categories and/or lifecycle stage cycles to the application feature identifying model 170 to identify relevant application features. In some implementations, in addition to the received file usage signal, identified user categories and/or lifecycle stage cycles, the application feature identifying model 170 may receive and examine contextual information related to the user and/or the file to identify the relevant application features. For example, the application feature identifying model 170 may retrieve user-specific information from the user data structure 116, which may be stored locally (e.g., in the client device 120), in the data store 152 and/or in any other storage medium. The user-specific information may include information about the user, in addition to people, teams, groups, organizations and the like that the user is associated with. In an example, the user-specific information may include information relating to a user's relationship with other users. For example, the information may include data about one or more people the user has recently collaborated with (e.g., has exchanged emails or other communications with, has had meetings with, or has worked on the same file with). In another example, the user-specific information may include people on the same team or group as the user, and/or people working on a same project as the user. The user-specific information may also include the degree to which the user is associated with each of the entities (e.g., with each of the teams on the list). In another example, the user-specific information may include information about a person's type of relationship to the user (e.g., the user's manager, the user's team member, the user's direct report, and the like). Moreover, the user-specific information may include the number of times and/or length of time the user has collaborated with or has been associated with each person.

In some implementations, the user-specific information is retrieved from one or more remote or local services, such as a directory service, a collaboration service, a communication service, and/or a productivity service background framework and stored in a user-specific data structure, such as the user data structure 116. Alternatively, the user-specific information may simply be retrieved from the local and/or remote services, when needed.

In some implementations, for additional accuracy and precision, the ML models may include a personalized model, a global model and/or a hybrid model. For example, some application features may be determined to be relevant application features across the population. For those application features, a global model may be used to identify the relevant application features. The global model may identify relevant application features for a large number of users and use the identified application features for all users. Other application features may only be relevant to specific users. For example, if a user's usage signal for a file indicates the user often changes the font after pasting a paragraph, changing the font may be considered a relevant application features once the user pastes a new paragraph. A personalized model can identify such personalized relevant application features. A hybrid model may be used to identify relevant application features for users that are associated with and/or similar to the user. By using a combination of personalized, hybrid and/or global models, more relevant application features may be identified for a given user.

In addition to utilizing the user's data to train the ML models disclosed herein, data from other users that are similar to the current user may also be used. For example, in identifying relevant application features, the ML model may use feedback data from users with similar activities, similar work functions and/or similar work products to the user. The data consulted may be global or local to the current device.

In collecting and storing any user usage signal data and/or user feedback, care must be taken to comply with privacy guidelines and regulations. For example, user feedback may be collected and/or stored in such a way that it does not include user identifying information and is stored no longer than necessary. Furthermore, options may be provided to seek consent (e.g., opt-in) from users for collection and use of user data, to enable users to opt-out of data collection, and/or to allow users to view and/or correct collected data.

Using ML models that are offered as part of a service (e.g., the adaptable UI service 114) may ensure that the list of relevant application features can be modified iteratively and efficiently, as needed, to continually train the models. However, a local relevant application features identifying engine may also be provided. Alternatively or additionally, instead of operating as part of the adaptable UI service 114, the application feature identifying model 170 may function as a separate service. When a separate activity identifying service or local engine is used, the usage signal may be sent to the application feature identifying service or local engine, such as at the same time it is sent to the user categorizing service.

In some implementations, the application feature identifying model 170 may use the file usage signal collected and stored over multiple sessions to identify the relevant application features. The file usage signal may be the usage signal for the current user and/or the usage signal for users associated with the current user. For example, if the usage signal indicates that the user's manager created a presentation document, added content to the document, transitioned to making formatting changes only, and then sent the document to the current user, the usage signals about the manager performing formatting tasks could be used to determine whether an application feature is relevant to the current user and as such should be proactively presented to the user. In another example, if the user's history of usage signal for the file indicates the user is likely to make major modifications to the content of the file (e.g., a presentation document) and the content is similar to that of other files, then a reuse slides application feature may be identified as being a relevant application feature.

In addition to the usage signal, the identified user categories, and/or lifecycle stages may also be used to identify relevant application features. For example, when the user category signal indicates that the last time the user interacted with a file, they functioned as a reviewer, the next time the user opens that file, the application may more prominently display application features that are relevant to the activity of reviewing (e.g., new comment, track changes, etc.). Similarly, if the lifecycle stage of the file indicates the current or most recent lifecycle stage is in review, then application features more relevant to reviewing functions may be displayed more prominently. In addition to examining the identified user categories of the current user, identifying the relevant features may be based on the user's relationship to other users who have interacted with the file. For example, if the user's colleague whom the user works with closely has recently functioned as a formatter of a file, then when the user opens the same file, application features relating to formatting may be displayed more prominently. More prominent display of relevant application features may involve the UI screen of the application being updated to display the identified relevant application features in UI elements that are more noticeable (e.g., on the ribbon).

Once the relevant application features have been identified, data about the identified application features may be provided to the adaptable UI engine 172 to determine how and if the identified application features should be presented to the user. This may involve examining the identified application features, evaluating UI elements associated with the application features (e.g., they are normally shown under the review tab in the toolbar), and determining how the application features should be presented to the user. For example, the adaptable UI engine 172 may determine if the identified application features should be presented proactively (e.g., in a pop-up menu or pop-up pane) or be added to a toolbar at the top of the application.

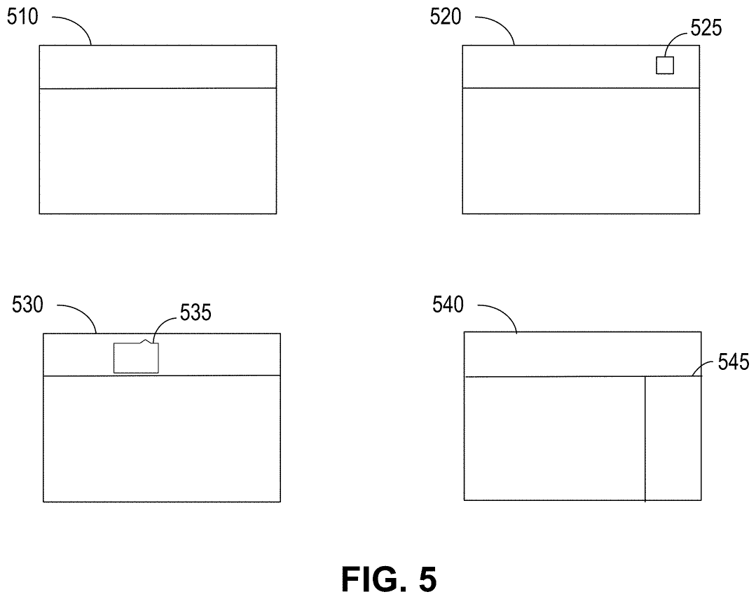

In some implementations, in determining how to present the identified application features, a relevance score associated with the identified application features may be examined. The relevance score may be calculated by the application feature identifying model 170 and may indicate a likely level of relevance for the application feature. In some implementations, the relevance score may be determined based on rules or heuristics. When the identified application feature has a high relevance score, then the adaptable UI engine 172 may determine that it should be presented proactively. The relevance score may also be used in determine the degree with which the application feature is proactively presented, as discussed in more detail with respect to FIG. 5.

Once the adaptable UI engine 172 determines how to present the identified application features, data relating to the identified application features and the manner by which they should be presented may be transmitted by the adaptable UI service 114 to the applications 126/112 for display to the user.

The local user categorizing engine 124, lifecycle determination engine 128, and/or adaptable UI engine 132 f the client device 120 (in FIG. 1A) may include similar elements and may function similarly to the user categorizing service 140, lifecycle determination service 142, and/or adaptable UI service 114 (as depicted in FIG. 1B).

FIG. 1C depicts how one or more ML models used by the user categorizing service 140, lifecycle determination service 142, and/or adaptable UI service 114 may be trained by using the training mechanism 144. The training mechanism 144 may use training data sets stored in the data store 152 to provide initial and ongoing training for each of the models included in the user categorizing service 140, lifecycle determination service 142, and/or adaptable UI service 114. For example, each of the user categorizing model 166 and application feature identifying model 170 may be trained by the training mechanism 144 using corresponding data sets from the data store 152. To provide ongoing training, the training mechanism 144 may also use training data sets received from each of the ML models. Furthermore, data may be provided from the training mechanism 144 to the data store 152 to update one or more of the training data sets in order to provide updated and ongoing training. Additionally, the training mechanism 144 may receive training data such as knowledge from public repositories (e.g., Internet), knowledge from other enterprise sources, or knowledge from other pre-trained mechanisms.

FIG. 2 depicts an example data structure 200, such as a database table, for keeping track of user activity within a session. For example, data structure 200 may include a session start time 210 and a session end time 240. The session start time 210 may be marked as the time the user opens a file and/or the time the user returns to an open file after an idle period. The session end time 240, on the other hand, may be marked as the time the file is closed or the time the last user activity occurs before the file becomes idle. In between the session start time 210 and the session end time 240, the data structure 200 may be used to keep track of user activities by recording activity identifiers 230 (e.g., TCIDs) associated with each separate user activity. Furthermore, in order to identify the user who performs the activities, the data structure 200 may store the user ID 220 of the person interacting with the file.

In some implementations, in addition to storing the user activity identifier 230, information about the activities performed may be stored. This may be done for specific predetermined activities. For example, authoring (e.g., writing one or more sentences in a word document) may be identified as a predetermined activity. In some cases, one or more ML models may be used to determine the subject matter of the content authored by the user. This may be achieved by utilizing natural-language processing algorithms, among others. The subject matter may then be stored in the subject matter field 235 in the data structure 200.

In some implementations, once a determination is made that a session end time has been reached, the information collected during the session may be transmitted as part of the usage signal to the user categorizing service and/or the lifecycle determination service for use in identifying one or more user categories for the corresponding session, a lifecycle stage for the file and/or one or more relevant application features. The usage signal may be a high-fidelity signal which includes detailed information about the types of activities performed on the file within a given time period. In some implementations, the usage signal is transmitted and/or stored periodically and not just when the session ends.

After the usage signal has been used to generate a user category signal, the user category signal may be transmitted to the application and/or to the storage medium storing the file to be stored, e.g., in a graph for future use. In some implementations, the user category signal may include the identified user category, the file ID, user ID, session date and time, and/or session length. In some implementations, the user category signal may also include the subject matter(s) identified and stored in the usage signal.

The user category provided as part of the user category signal may be the category identified as being associated with the user's activity. In some implementations, categories may include one or more of creator, author, reviewer, moderator, and reader. The file ID may be a file identifier that can identify the file with which the user activity is associated. This may enable the user category signal to be attached to the file. In one implementation, the user category signal is stored as metadata for the file. The user ID may identify the user who performed the user activities during the session. This may enable the system to properly attribute the identified category of activities to the identified user.

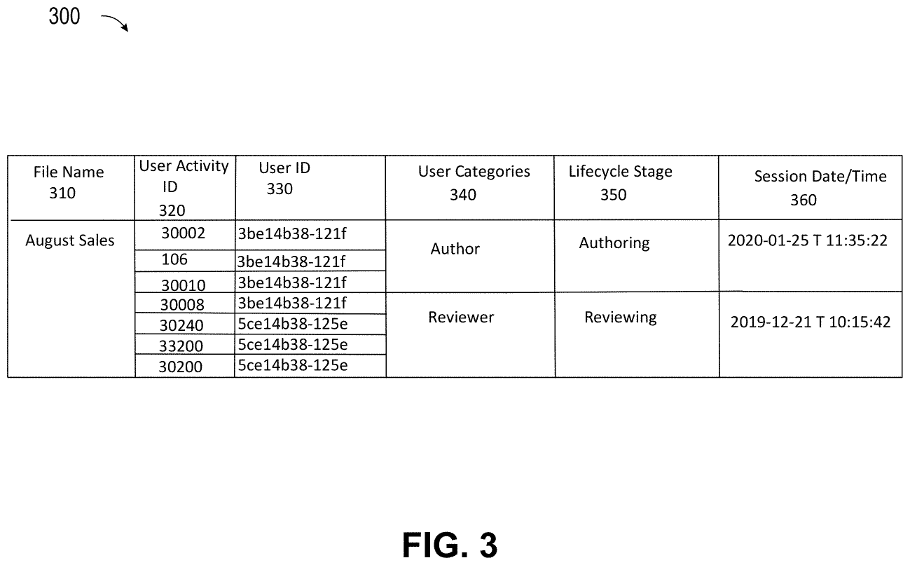

FIG. 3 depicts example properties associated with a file that may be used to provide an intelligent user experience in an application. The data structure 300 of FIG. 3 may be a database table containing information that may be related to relevant application features. Data structure 300 may include a file name column 310, user activity ID column 320, user ID column 330, user categories column 340, lifecycle stage 350, and session date/time 360.

The file name 310 may be the file name utilized to store the file. Alternatively, the file name may be a file ID (e.g., a file identifier that is different than the file name) used to identify the file. In some implementations, the file name includes information about the location at which the file is stored. The user activity ID column 320 may contain a list of activities (e.g., file usage signal) performed in the file during various application sessions. The user activity ID column 320 along with the user ID column 330 may provide information about the types of user activities performed in the file by a given user during various application sessions.

The user categories column 340 may include user categories identified for the file for each session. For example, the user categories 340 may include the categories that have been identified for the file for various sessions since its creation or for a particular time period. The lifecycle stage column 350 may contain a list of identified lifecycle stages of the file. Each of the user activity ID, user categories and/or lifecycle stages may be used to identify relevant application features. To allow for examining the user activity ID, user categories and/or lifecycle stages based on their recency, the data structure 300 may also include the session date and/or time for each identified user category.

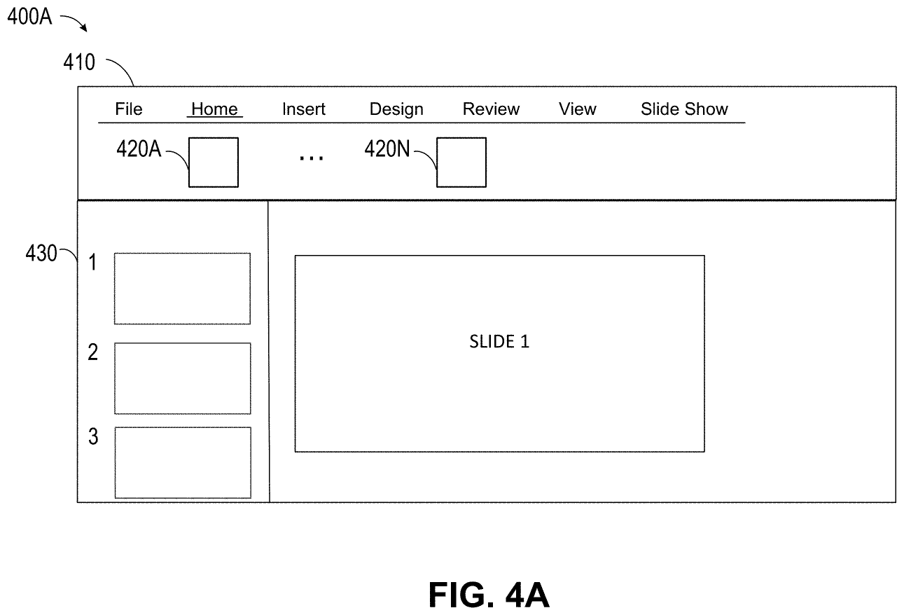

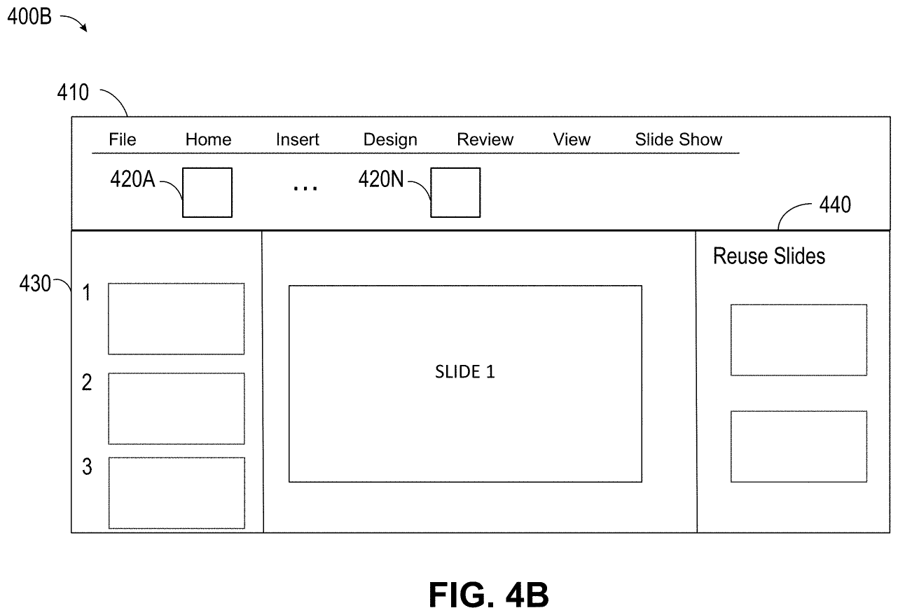

FIGS. 4A-4B depict example GUI screens for proactive display of relevant application features. The GUI screens 400A-400B of FIGS. 4A-4B may for example be displayed by a presentation application that is also used for preparing presentation materials (e.g., digital presentation slides) for display during a presentation. In an example, the UI screen 400A-400B of the presentation application or service may include a toolbar menu 410 that may display multiple tabs for providing various menu options. The toolbar menu 410 may organize various menu options under different menu tabs (e.g., File, Home, Insert, etc.). When selected, each of the menu tabs may display various menu options such as menu options 420A-420N. The UI screens 400A-400B may also include a content pane 430 which may contain one or more sections. In an example, the content pane 430 may include a section for displaying thumbnails of the slides in the presentation and a section for displaying in a larger size a selected slide from among the slides shown on the left.

While the user is interacting with the screen 400A of FIG. 4A and/or when the user first opens the file, the application may transmit a request to an adaptable UI service such as the adaptable UI service 114 of FIGS. 1A-1B to identify relevant application features for display. In some implementations, the adaptable UI service may identify relevant application features that should be proactively presented to the user. Upon transmitting this information to the application displaying the screen 400A, the application may proactively display the identified application feature as depicted in GUI screen 400B of FIG. 4B. Thus, when it is determined, for example, that the reuse slides feature is a relevant application feature and that its relevance indicates a need for its proactive display, the reuse slides pane 440 may be displayed in the screen 400B to enable the user to quickly access the feature.

In addition to determining when to proactively display an application feature, the technical solutions disclosed herein may ascertain when proactive display of an application feature is not appropriate based on the file usage signal over one or more sessions, user category signal and/or lifecycle stage of the file. This may provide a significant improvement in accurately predicting when a user may find an application feature useful. Instead of utilizing a hard-coded trigger (e.g., if a user performs a certain action, then a specific application feature is launched) or utilizing only user history data from a current application session, the technical solutions disclosed herein make use of the file usage signal across multiple sessions of the current user and/or of one or more of the user's collaborators. This results in identifying more targeted relevant application features and thus significantly improves the user's experience.

FIG. 5 depicts example GUI screens for providing various degrees of proactively displaying an application feature. GUI screen 510 displays a screen of an application where it was determined an application feature should not be proactive displayed in the UI screen. For example, upon examining file usage signal and/or other data, the adaptable UI service may have determined that the application feature is not relevant enough to be displayed. GUI screen 520, on the other hand, displays a screen of an application where it was determined that an application feature is relevant enough to be displayed, but the degree of its relevance is not high enough to warrant a prominent display of the application feature. As a result, the application feature may be presented via a less prominent UI element 525 such as the small menu option displayed in screen 520.

GUI screen 530 displays an application screen where an identified relevant application feature is determined to have higher relevance than the application feature of GUI screen 520. As a result, the application feature is displayed using the UI element 535 which is displayed at a more prominent location on the screen (e.g., close to the middle of the ribbon) and is larger in size than the UI element 525. When a relevant application feature is identified as having a high degree of relevance, the application feature may be presented via still more prominent UI elements. For example, as displayed in the GUI screen 540, a separate pane 545 may be utilized for proactive display of the identified application feature. The type of UI element used for an identified relevant application feature may depend on the relevance of the application feature, which may be determined by a relevance score, and/or it may depend on the type of application feature and the UI elements typically used for that type of application feature. Thus, by utilizing the file usage signal in identifying application features, the mechanisms disclosed herein can also take into the degree of relevance of an application feature in the manner the application feature is presented.

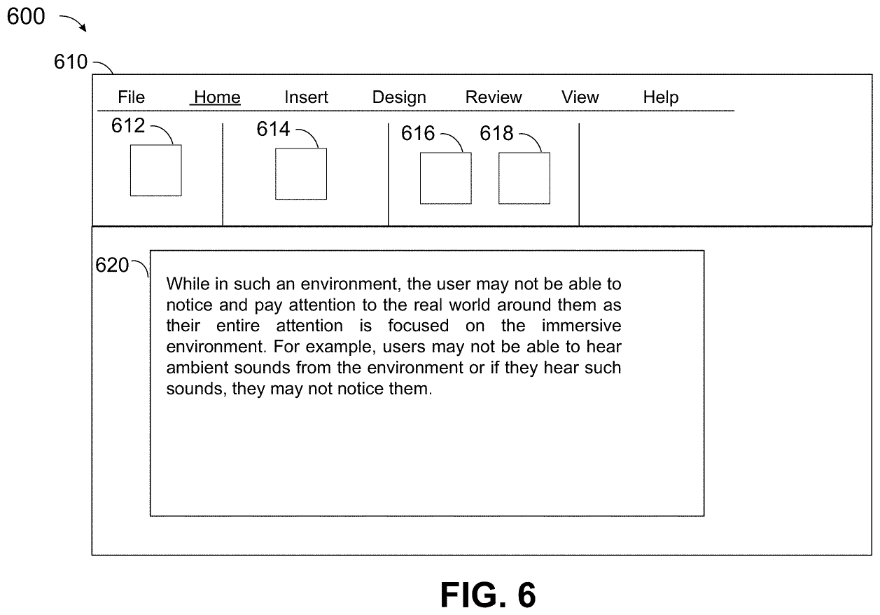

FIG. 6 is an example GUI screen 600 of a word processing application (e.g., Microsoft Word®) displaying an example document. GUI screen 600 may include a toolbar menu 610 containing various tabs each of which may provide multiple menu buttons such as menu buttons 612, 614, 616, and 618. Each of the menu buttons may represent an application feature offered by the word processing application. For example, the menu buttons may provide commands to create or edit the document. Screen 600 may also contain a content pane 620 for displaying the content of the document. The contents may be displayed to the user for viewing and/or editing purposes and may be created by the user.

As the user is interacting with the document and as such is generating file usage signals, or when the document is being opened, the file usage signals along with the user category signal and/or lifecycle stage signal may be analyzed to identify relevant application features. In some implementations, if it is determined, in response to analyzing the signals, that more than one relevant application feature has been identified or that the identified application features fall under the same category of application features (e.g., same toolbar tabs), the tab displayed in the toolbar menu may be changed to display a tab that includes one or more of the identified relevant application features. For example, the screen may be switched from displaying the Home tab menu buttons to the design menu buttons. Alternatively, the tab may not change but one or more of the displayed menu buttons may be removed and replaced with menu buttons associated with the identified relevant application features. In another example, menu buttons may be added to the ribbon for the identified relevant application features. Thus, in addition to proactive display of application features, currently displayed UI elements of the UI screen may be changed to accommodate the display of the newly identified relevant application features. Thus, application features may be provided in a user-friendly and convenient manner for easy access and use.

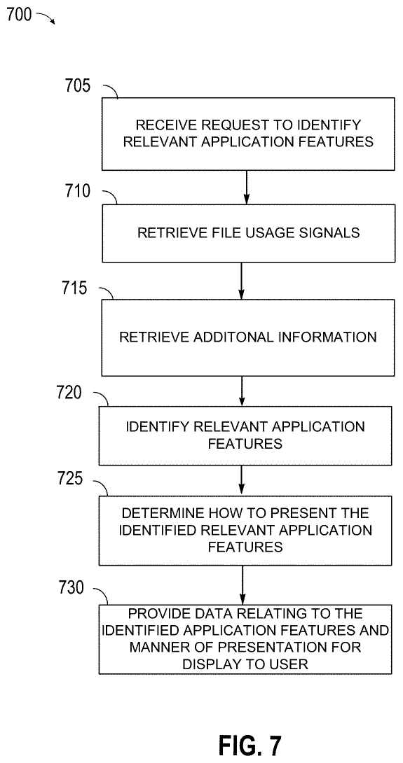

FIG. 7 is a flow diagram depicting an exemplary method 700 for intelligently identifying and presenting relevant application features. The method 700 may be performed by an adaptable UI service or a local adaptable UI engine such as the adaptable UI service 114 or adaptable UI engine 132 of FIGS. 1A-1C. At 705, method 700 may begin by receiving a request to identify relevant application features for a file in a given session. This may include an active session for a file which is currently open or is being opened. Thus, the request to identify relevant application features may be received from an application upon the application's launch (e.g., a file being opened via the application), periodically (e.g., based on a schedule) during an active application session, and/or when certain activities are performed in the file (e.g., upon specific user actions performed in the file). In some implementations, the request is transmitted from the application.

Upon receiving the request, the adaptable UI service may retrieve the file's usage signals, at 710. This may include usage signals over various sessions. For example, the usage signal may be retrieved for all sessions since the file's creation or for specific time periods. In an example, the usage signal from recent sessions may be retrieved. Alternatively, only the usage signal from the current application session may be retrieved.

After retrieving the file usage signals, method 700 may proceed to retrieve additional information, at 715. This may include user-specific information. For example, information about the user's relationships with other users associated with the file (e.g., users who have usage signals for the file) may be retrieved to determine whether the usage signal of other users should also be taken into account. Furthermore, the additional information retrieved may include user category signals and/or lifecycle stages of the file.

Once the required information is retrieved, method 700 may proceed to identify relevant application features, at 720. This may be done by utilizing one or more ML models as discussed above and may involve analyzing the file usage signal and/or the additional retrieved information to identify the relevant application features based on the retrieved signals. In some implementations, in addition to identify relevant application features, a degree of relevance of the identified application feature may also be calculated. For example, a relevance score may be calculated for each application feature and the relevant application features may be identified based on their relevance score. In an example, this involves comparing the relevance score to a threshold value and selecting the application feature as a relevant application feature when the relevance score satisfies the threshold value.

After the relevant application features have been identified, method 700 may proceed to determine how to present the identified application features, at 725. This may involve determining whether the application feature should be proactively launched, and if so the degree of its proactive launch (e.g., via a small menu button or a pop-up menu or pane). As discussed above, this may be achieved by examining the relevance score of the application feature and determining its degree of relevance. Moreover, the process of determining how to present the identified application features may include examining UI elements commonly used to display the relevant application feature, whether more than one application feature has been identified and is whether the identified application features are related, among other factors. Once method 700 determines how to present the identified relevant application features, data relating to the relevant application features and the manner in which they should be presented may be transmitted to the application for use in display of the identified application feature.

FIG. 8 is a block diagram 800 illustrating an example software architecture 802, various portions of which may be used in conjunction with various hardware architectures herein described, which may implement any of the above-described features. FIG. 8 is a non-limiting example of a software architecture and it will be appreciated that many other architectures may be implemented to facilitate the functionality described herein. The software architecture 802 may execute on hardware such as client devices, native application provider, web servers, server clusters, external services, and other servers. A representative hardware layer 804 includes a processing unit 806 and associated executable instructions 808. The executable instructions 808 represent executable instructions of the software architecture 802, including implementation of the methods, modules and so forth described herein.

The hardware layer 804 also includes a memory/storage 810, which also includes the executable instructions 808 and accompanying data. The hardware layer 804 may also include other hardware modules 812. Instructions 808 held by processing unit 808 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks 818, applications 820, and a presentation layer 824. Operationally, the applications 620 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks 818 (also sometimes referred to as middleware) provide a higher-level common infrastructure that may be used by the applications 820 and/or other software modules. For example, the frameworks 818 may provide various GUI functions, high-level resource management, or high-level location services. The frameworks 818 may provide a broad spectrum of other APIs for applications 820 and/or other software modules.

The applications 820 include built-in applications 820 and/or third-party applications 822. Examples of built-in applications 820 may include, but are not limited to, a contacts application, a browser application, a location application, a media application, a messaging application, and/or a game application. Third-party applications 822 may include any applications developed by an entity other than the vendor of the particular system. The applications 820 may use functions available via OS 814, libraries 816, frameworks 818, and presentation layer 824 to create user interfaces to interact with users.

Some software architectures use virtual machines, as illustrated by a virtual machine 828. The virtual machine 828 provides an execution environment where applications/modules can execute as if they were executing on a hardware machine (such as the machine 800 of FIG. 8, for example). The virtual machine 828 may be hosted by a host OS (for example, OS 814) or hypervisor, and may have a virtual machine monitor 826 which manages operation of the virtual machine 828 and interoperation with the host operating system. A software architecture, which may be different from software architecture 802 outside of the virtual machine, executes within the virtual machine 828 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement methods or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multi-core processor including cores that may execute instructions contemporaneously. Although FIG. 9 shows multiple processors, the machine 900 may include a single processor with a single core, a single processor with multiple cores (for example, a multi-core processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “computer-readable medium” refers to a device able to temporarily or permanently store instructions and data that cause machine 900 to operate in a specific fashion. The term “computer-readable medium,” as used herein, may include both communication media (e.g., transitory electrical or electromagnetic signals such as a carrier wave propagating through a medium) and storage media (i.e., tangible and/or non-transitory media). Non-limiting examples of a computer readable storage media may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “computer-readable storage media” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “computer-readable storage media” may refer to a single storage device, as well as “cloud-based” storage systems or storage networks that include multiple storage apparatus or devices.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956 and/or position components 962, among a wide array of other environmental sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 962, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-7) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
   a processor; and
   a memory in communication with the processor, the memory storing executable instructions that, when executed by the processor, cause the data processing system to perform functions of:
      receiving a request to identify one or more relevant application features for a file, the one or more relevant application features being application features offered by an application associated with the file;
      retrieving a file usage signal, the file usage signal being a signal stored with the file and including data about user actions performed in the file over one or more application sessions;
      providing the file usage signal as an input to a machine-learning (ML) model to identify the one or more relevant application features based on the file usage signal; receiving from the ML model the identified one or more relevant application features; determining a manner by which the identified one or more relevant application features should be presented for display; and
      providing data relating to at least one of the identified relevant application features or the manner by which the identified relevant application should be presented to the application.
Item 2. The data processing system of item 1, wherein the memory further stores executable instructions that, when executed by, the processor cause the processor to perform functions of:
   retrieving additional information, the additional information including at least one of data about relationships between a current user of the file and other users of the file, file usage signal of other users who are associated with the current user, a user category signal, and a file lifecycle stage signal; and
   providing the additional information to the ML model,
   wherein the ML model identifies the one or more relevant application features based on the file usage signal and the additional information.
Item 3. The data processing system of items 1 or 2, wherein the manner by which the identified one or more relevant application features should be presented includes at least one of proactively displaying a UI element associated with the identified one or more relevant application features on a user interface screen of the application or silencing the UI element associated with the identified one or more relevant application features.
Item 4. data processing system of any of the preceding items, wherein a type of UI element used to display the identified one or more relevant application features depends on a degree of relevance of the identified one or more relevant application features.
Item 5. The data processing system of item 4, wherein the degree of relevance of the identified one or more relevant application features is determined based on a relevance score.
Item 6. The data processing system of item 4, wherein a higher relevance score is associated with a more prominent display of the identified one or more relevant application feature.
Item 7. The data processing system of any of the preceding items, wherein the manner by which the identified one or more relevant application features should be presented includes adapting a user interface screen of the application.
Item 8. A method for intelligently identifying one or more relevant application features comprising:
   receiving a request to identify the one or more relevant application features for a file, the one or more relevant application features being application features offered by an application associated with the file;
   retrieving a file usage signal, the file usage signal being a signal stored with the file and including data about user actions performed in the file over one or more application sessions;
   providing the file usage signal as an input to a machine-learning (ML) model to identify the one or more relevant application features based on the file usage signal;
   receiving from the ML model the identified one or more relevant application features;
   determining a manner by which the identified one or more relevant application features should be presented for display; and
   providing data relating to at least one of the identified relevant application features or the manner by which the identified relevant application should be presented to the application.
Item 9. The method of item 8, further comprising:
   retrieving additional information, the additional information including at least one of data about relationships between a current user of the file and other users of the file, file usage signal of other users who are associated with the current user, a user category signal, and a file lifecycle stage signal; and
   providing the additional information to the ML model,
   wherein the ML model identifies the one or more relevant application features based on the file usage signal and the additional information.
Item 10. The method of items 8 or 9, wherein the manner by which the identified one or more relevant application features should be presented includes at least one of proactively displaying a UI element associated with the identified one or more relevant application features on a user interface screen of the application or silencing the UI element associated with the identified one or more relevant application features.
Item 11. The method of any of items 8-10, wherein a type of UI element used to display the identified one or more relevant application features depends on a degree of relevance of the identified one or more relevant application features.
Item 12. The method of item 11, wherein the degree of relevance of the identified one or more relevant application features is determined based on a relevance score.
Item 13. The method of item 11, wherein a higher relevance score is associated with a more prominent display of the identified one or more relevant application feature.
Item 14. The method of any of items 8-13, wherein the manner by which the identified one or more relevant application features should be presented includes adapting a user interface screen of the application.
Item 15. A non-transitory computer readable medium on which are stored instructions that, when executed, cause a programmable device to:
   receive a request to identify one or more relevant application features for a file, the one or more relevant application features being application features offered by an application associated with the file;
   retrieve a file usage signal, the file usage signal being a signal stored with the file and including data about user actions performed in the file over one or more application sessions;
   provide the file usage signal as an input to a machine-learning (ML) model to identify the one or more relevant application features based on the file usage signal; receive from the ML model the identified one or more relevant application features; determine a manner by which the identified one or more relevant application features should be presented for display; and
   provide data relating to at least one of the identified relevant application features or the manner by which the identified relevant application should be presented to the application.
Item 16. The non-transitory computer readable medium of item 15, wherein the instructions further cause the programmable device to:
   retrieve additional information, the additional information including at least one of data about relationships between a current user of the file and other users of the file, file usage signal of other users who are associated with the current user, a user category signal, and a file lifecycle stage signal; and
   provide the additional information to the ML model,
   wherein the ML model identifies the one or more relevant application features based on the file usage signal and the additional information.
Item 17. The non-transitory computer readable medium of items 15 or 16, wherein the manner by which the identified one or more relevant application features should be presented includes at least one of proactively displaying a UI element associated with the identified one or more relevant application features on a user interface screen of the application or silencing the UI element associated with the identified one or more relevant application features.
Item 18. The non-transitory computer readable medium of any of items 15-17, wherein a type of UI element used to display the identified one or more relevant application features depends on a degree of relevance of the identified one or more relevant application features.
Item 19. The non-transitory computer readable medium of item 18, wherein the degree of relevance of the identified one or more relevant application features is determined based on a relevance score.
Item 20. The non-transitory computer readable medium of any of items 15-19, wherein the manner by which the identified one or more relevant application features should be presented includes adapting a user interface screen of the application.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory storing executable instructions that, when executed by the processor, cause the data processing system to perform functions of:
receiving a request to identify one or more relevant application features for a file, the one or more relevant application features being application features offered by an application associated with the file;
retrieving a file usage signal, the file usage signal being a signal stored with the file and including data about user actions performed in the file over one or more application sessions;
providing the file usage signal as an input to a machine-learning (ML) model to identify the one or more relevant application features based on the file usage signal;
receiving from the ML model the identified one or more relevant application features;
determining a manner by which the identified one or more relevant application features should be presented for display; and
providing data relating to at least one of the identified relevant application features or the manner by which the identified relevant application should be presented to the application.

2. The data processing system of claim 1, wherein the memory further stores executable instructions that, when executed by, the processor cause the processor to perform functions of:
retrieving additional information, the additional information including at least one of data about relationships between a current user of the file and other users of the file, file usage signal of other users who are associated with the current user, a user category signal, and a file lifecycle stage signal; and
providing the additional information to the ML model,
wherein the ML model identifies the one or more relevant application features based on the file usage signal and the additional information.

3. The data processing system of claim 1, wherein the manner by which the identified one or more relevant application features should be presented includes at least one of proactively displaying a UI element associated with the identified one or more relevant application features on a user interface screen of the application or silencing the UI element associated with the identified one or more relevant application features.

4. The data processing system of claim 1, wherein a type of UI element used to display the identified one or more relevant application features depends on a degree of relevance of the identified one or more relevant application features.

5. The data processing system of claim 4, wherein the degree of relevance of the identified one or more relevant application features is determined based on a relevance score.

6. The data processing system of claim 4, wherein a higher relevance score is associated with a more prominent display of the identified one or more relevant application feature.

7. The data processing system of claim 1, wherein the manner by which the identified one or more relevant application features should be presented includes adapting a user interface screen of the application.

8. A method for intelligently identifying one or more relevant application features comprising:
receiving a request to identify the one or more relevant application features for a file, the one or more relevant application features being application features offered by an application associated with the file;
retrieving a file usage signal, the file usage signal being a signal stored with the file and including data about user actions performed in the file over one or more application sessions;
providing the file usage signal as an input to a machine-learning (ML) model to identify the one or more relevant application features based on the file usage signal;
receiving from the ML model the identified one or more relevant application features;
determining a manner by which the identified one or more relevant application features should be presented for display; and
providing data relating to at least one of the identified relevant application features or the manner by which the identified relevant application should be presented to the application.

9. The method of claim 8, further comprising:
retrieving additional information, the additional information including at least one of data about relationships between a current user of the file and other users of the file, file usage signal of other users who are associated with the current user, a user category signal, and a file lifecycle stage signal; and
providing the additional information to the ML model,
wherein the ML model identifies the one or more relevant application features based on the file usage signal and the additional information.

10. The method of claim 8, wherein the manner by which the identified one or more relevant application features should be presented includes at least one of proactively displaying a UI element associated with the identified one or more relevant application features on a user interface screen of the application or silencing the UI element associated with the identified one or more relevant application features.

11. The method of claim 8, wherein a type of UI element used to display the identified one or more relevant application features depends on a degree of relevance of the identified one or more relevant application features.

12. The method of claim 11, wherein the degree of relevance of the identified one or more relevant application features is determined based on a relevance score.

13. The method of claim 11, wherein a higher relevance score is associated with a more prominent display of the identified one or more relevant application feature.

14. The method of claim 8, wherein the manner by which the identified one or more relevant application features should be presented includes adapting a user interface screen of the application.

15. A non-transitory computer readable medium on which are stored instructions that, when executed, cause a programmable device to:
receive a request to identify one or more relevant application features for a file, the one or more relevant application features being application features offered by an application associated with the file;
retrieve a file usage signal, the file usage signal being a signal stored with the file and including data about user actions performed in the file over one or more application sessions;
provide the file usage signal as an input to a machine-learning (ML) model to identify the one or more relevant application features based on the file usage signal;
receive from the ML model the identified one or more relevant application features;
determine a manner by which the identified one or more relevant application features should be presented for display; and
provide data relating to at least one of the identified relevant application features or the manner by which the identified relevant application should be presented to the application.

16. The non-transitory computer readable medium of claim 15, wherein the instructions further cause the programmable device to:
retrieve additional information, the additional information including at least one of data about relationships between a current user of the file and other users of the file, file usage signal of other users who are associated with the current user, a user category signal, and a file lifecycle stage signal; and
provide the additional information to the ML model,
wherein the ML model identifies the one or more relevant application features based on the file usage signal and the additional information.

17. The non-transitory computer readable medium of claim 15, wherein the manner by which the identified one or more relevant application features should be presented includes at least one of proactively displaying a UI element associated with the identified one or more relevant application features on a user interface screen of the application or silencing the UI element associated with the identified one or more relevant application features.

18. The non-transitory computer readable medium of claim 15, wherein a type of UI element used to display the identified one or more relevant application features depends on a degree of relevance of the identified one or more relevant application features.

19. The non-transitory computer readable medium of claim 18, wherein the degree of relevance of the identified one or more relevant application features is determined based on a relevance score.

20. The non-transitory computer readable medium of claim 15, wherein the manner by which the identified one or more relevant application features should be presented includes adapting a user interface screen of the application.
